(19) United States
(12) Patent Application Publication
(10) Pub. No.: US 2003/0069959 A1
(43) Pub. Date: Apr. 10, 2003

(54) Alarm lists synchronization in an alarm management system

(76) Inventor: Edwin Tse, Montreal (CA)

Correspondence Address: ERICSSON RESEARCH CANADA, 8400 DECARIE BLVD., MONTREAL, QC, H4P 2N2, CA

(21) Appl. No.: 09/682,676

(22) Filed: Oct. 4, 2001

(51) Int. Cl. G06F 15/173

(52) U.S. Cl. 709/224; 709/221

(57) ABSTRACT

The present invention allows synchronizing alarm lists of two network entities of an Alarm Management System (AMS), such as the ones of an agent and a manager. The agent loses confidence in its Agent Alarm List (AAL) and decides to rebuild the AAL. It notifies its cooperating manager(s) via a rebuild notification (e.g. a NotifyFaultyAlarmList) of the ongoing or impending rebuild process with, preferably, a reason code indicating why rebuild is necessary. Upon receipt of the rebuild notification, the manager stops processing the Manager Alarm List (MAL) involving alarm notifications from the portion of the AAL being rebuilt, and purges these alarm notifications. Upon completion of the AAL rebuild, agent sends to the managers alarm notifications from the rebuilt AAL, preferably using alarm batches and/or a NotifyAlarmListRebuilt notification message. The manager(s) receives the alarm notifications and restores its/their MAL, and resume normal operation.

### BACKGROUND OF INVENTION

1. Field of the Invention

The present invention relates to network management, and in particular to alarm synchronization between two management network”s entities.

2. Description of the Related Art

Networks are widely employed nowadays in various areas of activity. Local Area Networks (LANs), Wide Area Networks (WANs), Public Local Mobile Networks (PLMN) are just a few examples of the uses made of networks for providing new or improved services to users and subscribers. In order to insure proper operation, each such network is typically monitored by a co-operating management network, also called herein an Event Management System (EMS), which acquires and processes data related to the activity and/or faults that occur in the Network Elements (NEs) of the monitored network. The NEs of the monitored network typically issue event notifications for various events (such as alarms) taking place in the network, such as for example for call set-ups, radio cell selections, hand-off failures in a PLMN, etc. The events are further collected by the EMS and processed in a manner defined by the network operator for providing for example indications of the level of service quality provided by the monitored network.

It is a particular function of the EMS to collect, process and display event-related information concerning the events and alarms issued by various elements of the monitored network. Events and alarms can be issued upon detection or assumption of an error in the monitored network, such as for example the failure of a Base Station (BS) transceiver in the PLMN. In such a case, the BS issues an alarm notification, which is sent to the EMS. For the purpose of handling and managing large quantity of alarms/events notifications from a large telecommunication managed network, the EMS may comprise one or more agents that are the management network”s entities responsible for receiving, processing and storing the alarms originating from the NEs of the managed network. For example, an Agent may receive the event notifications from the monitored network, process them by assigning an event identifier to the received notification and store the identified events/alarms in an internal Alarm List (AL). Thereafter, the agent can send a notification to one or more Managers, which are another type of entities of the EMS that may be dedicated to further processing the alarm notifications, such as for example by performing alarm correlation. Alternatively, managers may perform, for example, the actual management of the events and alarms, i.e. displaying the events and alarms for network administrators, thus allowing for example remedial actions to be taken for coping with the original malfunction that triggered the event/alarm notification.

Reference is now made to FIG. 1 (Prior Art), wherein there is shown an exemplary high-level block diagram of an Event Management System (EMS) 10 managing a network 12, such as for example a PLMN. The managed network 12 may comprise a plurality of NEs 14-50, such as for example a Mobile Switching Center 1 (MSC₁) 14, and MSC₂ 16, each comprising a plurality of devices Device , such as for example Device₁ 18 to Device₃ 22 for NE₁ (MSC₁) 14, and Device₄ 24 and Device₅ 26 for NE₂ (MSC₂) 16. Each such device may in turn comprise one or more components Cᵢ, such as for example Cₗ 28 to C₄ 34 for the Device₁ 8, and so on. In such a tree configuration, wherein certain NEs are comprised in another NE, itself comprised in yet another NEs, as well as in other types of configurations, each NE of the managed network (e.g. MSCs, devices, components, etc) may be identified by a Managed Object Instance (MOI), which identification is also used in the event or alarm notifications for referring to a particular NE. Upon occurrence of a specific trigger, such as for example upon detection of a given malfunction in an NE, an alarm notification is issued by the given NE and is transmitted to the agent responsible for the collection of event or alarm notifications generated by that specific branch of the managed network 12, such as for example to Agent 52. Upon receipt of the notification, Agent 52 can perform specific actions on that notification, and/or relay the notification to one or more of the managers 54 and 56. Thereafter, operators 58 to 62 may access the information relating that notification from at least one of managers 54 and 56. Since an important part of the processing of the EMS is based on alarm notifications, which are stored in agent(s) and manager(s) of the EMS, as opposed to event notifications that may be deleted upon receipt, it is to be noted that the appellation of “alarm” or “alarm notification” will be used herein, however, without any restriction, and being meant to also encompass any kind of event notification.

For the purpose of collecting alarm notifications, the Agent₁ 52 comprises an Alarm notification List (AL) stored in a memory, such as for example a database. It is to be understood that the alarm notifications collected in the list can be of various types, such as for example event notifications related to the normal operation of the managed network, alarm notifications related to specific malfunctions of the managed network, or any other type of notifications as set by a network operator/administrator. The AL content is continuously updated due to, for example, the regular occurrence and generation of alarm notifications by NEs, the issuance of new alarms, the change in the severity level of existing alarms, etc.

In some instances, the Agent 52 may experience AL integrity problems, i.e. the AL may become corrupted and is no longer certain to be consistent with the current alarm status of the NEs. For example, such instances may arise when the communication link between the agent and the monitored NEs is down and some alarm notifications may have been lost, or when the data medium of the agent (ex.: the hard disk drive) experiences a crash therefore loosing alarm-related data. In such instances, the agent needs to rebuild its AL. At that time, the Agent₁ 52 needs to notify the users of its information, such as for example managers 54 and 56, about its AL rebuilding process since the users may have duplicated and may be using the corrupted and inconsistent copy of the AL.

Although there is no prior art solution as the one proposed hereinafter for solving the above-mentioned deficiencies, various methods have been published for synchronization of multiple replicated information so that they are identical to each other.

The international network management standard 3GPP Alarm Integration Reference Point (IRP), Release 99 and Release 4, by the 3^{rd} Generation Partnership Project, standardized an alarm synchronization procedure for use between agent and manager. With reference being now made to FIG. 2 (Prior Art), wherein there is shown a high-level flowchart diagram illustrative of the prior art method described in the standard for synchronizing an alarm list of two nodes, an agent first rebuilds its alarm list, step 55 and, when the agent has rebuilt its alarm list, it sends notifications (NotifyAlarmListRebuilt notifications) to all cooperating managers about the AL rebuild fact, step 57. The managers then request (through a GetAlarmList operation) the agent to send a copy of the AL, step 59, and the agent responds by sending, to each requesting manager, the alarm notifications related to the rebuilt AL, step 61. However, this procedure requires extensive signalling between the agent and the manager since it implies the use of one notification message and one request message before the agent sends the AL copy to a manager. Furthermore, upon receipt of the AL rebuilt notifications, the managers may request the AL copy at slightly different times. The agent's AL content may have changed during this time and therefore the agent needs to maintain various copies of the AL to satisfy various managers” requests that may come at different times. Maintaining various copies of the AL is a further burden on the agent's resources.

The U.S. Pat. No. 5,742,820 discloses a mechanism for synchronizing information over a network, and suggests the use of an identifier generated by the original database to detect database content consistency. The identifier is sent to systems that hold a replicated database. Those systems generate another identifier using the replicated database and compare it with the incoming identifier. If the two identifiers are different, it is concluded that the databases” contents are also different, and the system will initiate the database synchronization procedure. However, this procedure is not adapted for alarm synchronization wherein the decision to initiate synchronization is solely taken by the agent.

It would be advantageous to have a simplified yet efficient mechanism for event notification list synchronization between an agent and at least one manager that solves all the above-identified deficiencies.

### SUMMARY OF INVENTION

It is therefore one broad object of this invention to provide a method, system, and first and second network entities for synchronizing alarm lists of two network entities of an Alarm Management System (AMS), such as the ones of an agent and a manager. According to the invention, the agent loses confidence in its Agent Alarm List (AAL) and decides to rebuild at least a portion of the AAL. It then notifies its cooperating manager(s) via a rebuild notification (e.g. a NotifyFaultyAlarmList notification) of the ongoing or impending rebuild process with, preferably, a reason (indicating why rebuild is necessary). Upon receipt of the rebuild notification, the manager(s) stop(s) the processing of its/their Manager Alarm List (MAL) involving alarm notifications from the portion of the AAL being rebuilt, and begin(s) to purge these alarm notifications. When the agent completes the rebuild of the AAL, it sends to the manager(s) the alarm notifications from the rebuilt AAL, preferably using batches having a plurality of alarm notifications, wherein alarm notifications of each batch are marked for differentiation. The manager(s) extracts the alarm notifications from the batches, restores its/their MAL, and resume normal operation. The agent can also use a NotifyAlarmListRebuilt notification for sending the rebuilt AAL to the manager(s).

### BRIEF DESCRIPTION OF DRAWINGS

For a more detailed understanding of the invention, for further objects and advantages thereof, reference can now be made to the following description, taken in conjunction with the accompanying drawings, in which:

FIG. 1 is a high-level block diagram illustrative of an Alarm Management System (AMS) where the preferred embodiment of the present invention can be implemented;

FIG. 2 is an exemplary flowchart diagram illustrative of a prior art method for alarm synchronization; and

FIG. 3 is an exemplary nodal operation and signaling diagram of the preferred embodiment of the present invention.

### DETAILED DESCRIPTION

In accordance with the above-mentioned objects, the present invention provides a method, system and corresponding network entities for synchronizing the alarm lists of two or more nodes of an Alarm Management System (AMS). In the context of the present invention, such nodes of the AMS can be an agent and a manager. An agent is a network entity of the AMS responsible for collecting event notifications and alarm notifications from managed network elements of a managed network, and for storing these alarm notifications pending clearance. For this purpose, the agent is typically connected to a plurality of Network Elements (NEs) of the managed network. The manager is another network entity of the AMS, typically connected to at least one agent and responsible for further processing alarm notifications received from the agent(s). While event notifications may be received by either the agent or the manager and purged upon receipt, alarm notifications are typically stored in internal lists of the agent and the manager, since they are typically representative of ongoing malfunctions (active alarms) in the managed network, and therefore must typically be stored and further analyzed in order to pinpoint and repair those malfunctions. Until the malfunctions are corrected, the alarm notifications are typically held in the alarm lists.

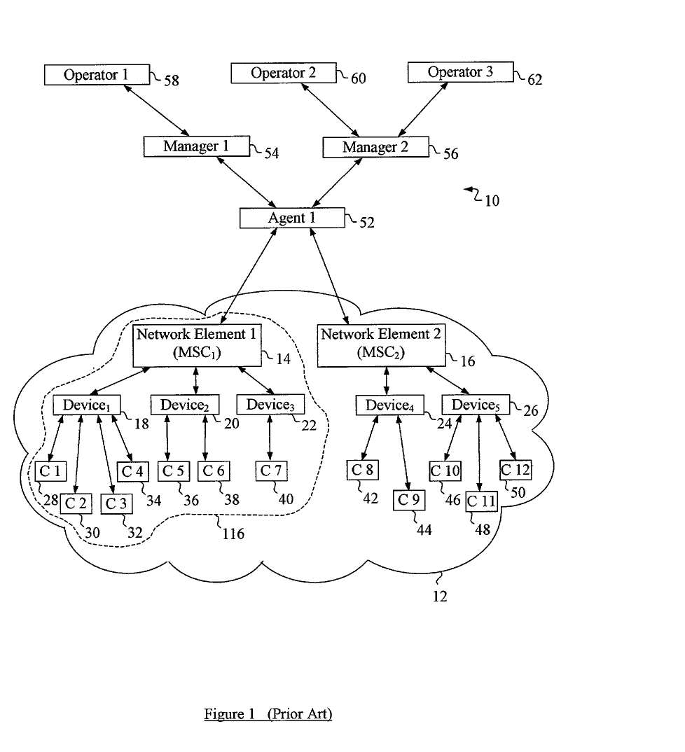

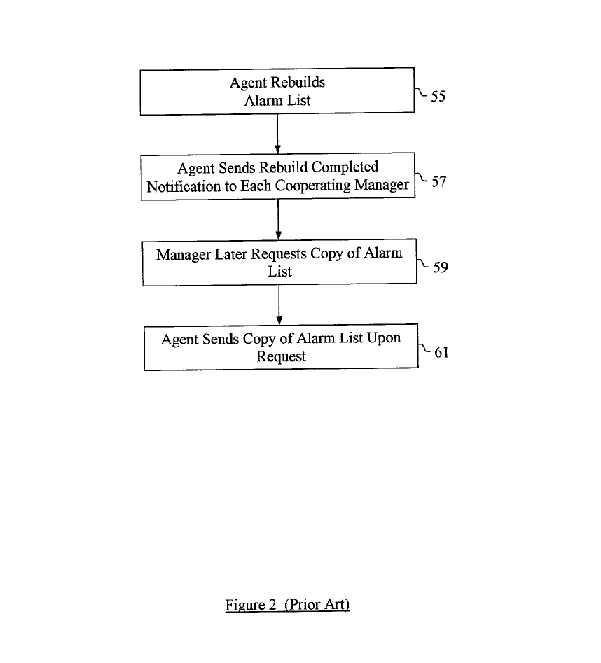

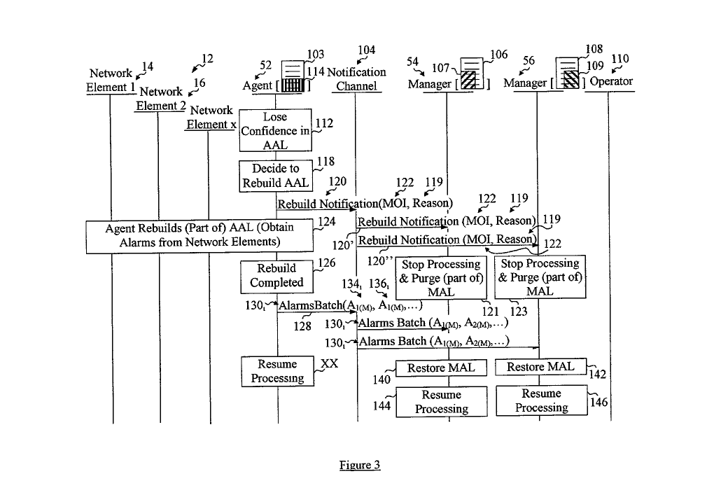

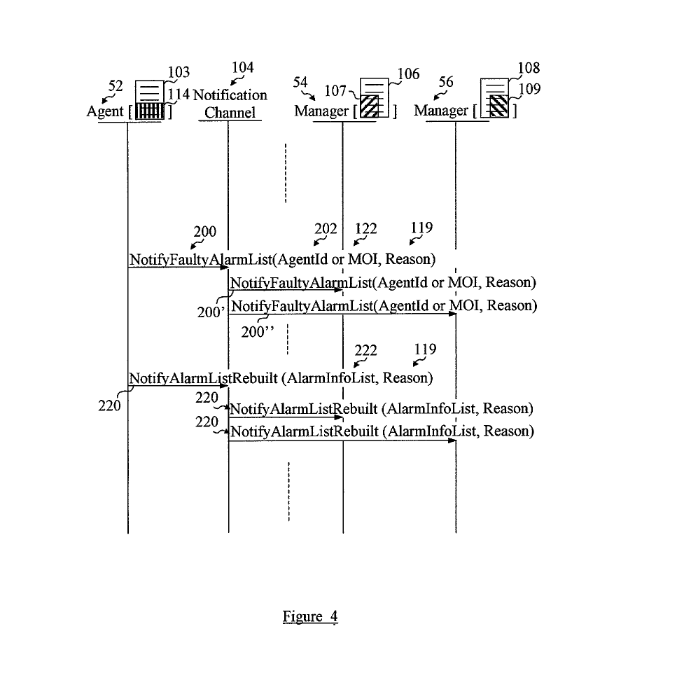

Reference is now made to FIG. 3, which shows an exemplary nodal operation and signaling diagram of the preferred embodiment of the present invention. Shown in FIG. 3 is an Alarm Management System (AMS) 100 monitoring a managed network 102 comprising a plurality of Network Elements (NEs), such as for example MSC₁ 14, MSC₂ 16, and Device₁ 18, which may in turn comprise a plurality of devices and components following a tree configuration as shown in FIG. 1. The AMS 100 further comprises an agent 52 having an Agent Alarm List (AAL) 103 for storing alarm notifications received from NEs 14, 16, and 18. The agent 52 may communicate through various types of communications links, such as for example through a Notification Channel 104, with at least one manager of the AMS 100, such as for example with managers 54 and 56, that may each have a Manager Alarm List (MAL) 106 and 108 respectively, for storing alarm notifications received from agent 52. It is to be noted that the alarm notifications received by the agent 52 from NEs 14, 16, and 18 may differ from the alarm modifications received by managers 54 and 56 from the agent 52, i.e., first, the alarm notifications sent from the agent 52 toward the managers may have been processed by the agent 52 (for example, the agent 52 may have correlated a set of alarm notifications received from network elements, and only send one alarm notifications representative of the set toward managers), and second, while the agent receives all alarm notifications from the NEs, it sends to a particular manager only alarm notifications that manager is interested to have. For example, if manager 54 is only interested to have alarm notifications regarding NE 14, the agent 52 receives alarm notifications from both network elements 14 and 16, but only relays alarm notifications originating from NE 14 to manager 54. The AMS 100 may further comprise an operator 110 that can access, view, and analyze the alarm information collected from managers 54 and 56. Although not shown in FIG. 3 for simplification purposes, it is understood that network elements, agents, managers and operators from FIG. 3 are connected with each other through appropriate links, interfaces, and filters, as it is known in the art.

With reference being particularly made to FIG. 3, the process starts when the agent 52 loses confidence in its AAL 103, action 112. Various factors may trigger action 112, such as for example when agent 52 detects communication link failure between itself and the network element, a crash of the agent”s data storage medium, a data processing error, or any other malfunction that could result in the alteration of the alarm data stored in the AAL 103. Action 112 may as well be applied to only a portion 114 of the AAL 103, such as for example to the AAL”s portion 114 which alarm notifications relate to a specific managed network”s part 116, as shown in FIG. 1, if, for instance, only that portion 114 of the AAL 103 lost data. Following action 112, the agent 52 decides to rebuild the AAL 103, or alternatively just the affected portion 114 of the AAL, in action 118. According to the preferred embodiment of the invention, upon deciding to rebuild the AAL, the agent 52 sends a Rebuild Notification 120 to its cooperating managers 54 and 56 for informing that it is in the process of rebuilding the AAL 103. The rebuild notification 120 may be sent via a notification channel 104, which upon receipt of the original Rebuild Notification 120, determines that the notification 120 is directed to both managers 54 and 56, and therefore relays Rebuild Notifications 120″ and 120″″ (which are copies of the Rebuilt Notification 120) to manager 54 and manager 56 respectively. The Rebuild Notifications 120, 120″, and 120″″ may comprise i) a Managed Object Instance (MOI) identification 122 for identifying the highest ranking NE of the managed network 12 whose related AAL portion is being rebuilt, and ii) an indication of the reason why the rebuilding is necessary, Reason 119. For example, in action 112, the agent 52 may have decided to only rebuild the portion 114 of the AAL 103, the AAL portion 114 comprising alarm notifications originating from the part 116 of the managed network 12, as shown in FIG. 1. The reason of the rebuilt may be, for example, a detection of a temporary interruption in the link between the Agent 52 and one or more NEs. Therefore, the agent 52 notifies the managers 54 and 56 by sending the rebuild notification 120 comprising the MOI 122 identifying the NE 14 which is the highest ranking network element of the managed network part 116 and whose related AAL portion 114 is being rebuilt, along with the Reason 119 indicative of the temporary interruption in the link between the Agent 52 and a given NE. Alternatively, the rebuild notification may comprise other kind of indication of the portion of the AAL 103 being rebuilt, or no identification at all. Upon receipt of the rebuild notification 120″ and 120″″, the managers 54 and 56 stop any processing of alarm notifications related to the MOI 122, and may also begin purging their MAL 106 and 108 respectively, or at least the alarm lists” portions 107 and 109 respectively where the alarm notifications related to the MOI 122 are stored, in actions 121 and 123. Alternatively, upon receipt of the rebuild notifications, the managers 54 and 56 may mark the concerned alarm notifications for subsequent deletion, log the concerned alarm notifications, inform the Operator 110 about the ongoing rebuild process of the AAL, or respond with a warning notification to attempts from operator 110 to acknowledge related alarm notifications. In a further alternative, if a given manager is set to only receive alarm notifications from one given agent, and if the MAL is substantially a copy of the AAL (substantially the same alarm information is stored in the AAL and the MAL), or if so desires a particular network operator, then the manager may stop all ongoing processing on the MAL, and purge the entire MAL.

Following the transmission of the rebuild notification 120, the agent 52 proceeds with a rebuild of its AAL 103, or of a portion 114 thereof, in action 124. During the rebuilt 124, the agent 52 may request and obtain from the related NEs all pending alarm notifications. For example, if the agent 52 rebuilds its entire AAL 103, it requests pending alarm notifications from all related NEs, such as NEs 14, 16, and 18 in FIG. 3. Alternatively, if for example the agent 52 rebuilds only portion 14 of the AAL 103, which portion comprises only alarm notifications originating from NE 14 and its lower-ranking NEs (part 116 of the managed network 12, shown in FIG. 1), then the agent 52 only requests pending alarm notifications from NE 14 and its lower-ranking NEs.

Once the rebuild of AAL 103 is completed, action 126, the agent 52 sends the alarm notifications obtained in action 124 to the managers 54 and 56, action 128. The transmission 128 may comprise individually sending all the newly received alarm notifications, or preferably, sending the alarm notifications in batches of a plurality of alarm notifications. For example, the transmission 128 may comprise one or more alarm batches 130ᵢ each having a series of alarm notifications 134ᵢ, 136ᵢ, and so on, where i designates the number of the alarms batch. The alarm notifications carried in the batch 130ᵢ may be marked (M) as belonging to a given batch for differentiating them from alarm records in other batches, and from other current alarm notifications being transmitted substantially at the same time to the same recipient and not registered in the AAL 103.

The transmission 128 may be effectuated via the notification channel 104 which relays each alarm batch 130ᵢ to the appropriate destination, such as for example to managers 54 and 56. Upon receipt of each alarm batch 130ᵢ, the recipient manager extracts the alarm notifications from the alarm batch and restores its MAL 106 and 108 respectively, action 140 and 142, or the portion previously purged in actions 121 and 123. Once all batches of alarm notifications are received, the managers can resume normal operation and processing involving their respective restored MAL, actions 144 and 146. Following the sending of the last alarm batch, the agent 52 also resumes normal operation and processing of its AAL 103, action 150. Particularly, the agent 52 may resume the emission of alarm notifications carrying new alarm information that has not been registered in the batches 130ᵢ, in the case such emission was interrupted during the transmission of the alarm batches.

It is also to be noted that various messages may be used for the implementation of the present invention, depending upon the communications protocol used in a given network, or upon the preference of a given network operator. For example, FIG. 4 shows another exemplary nodal operation and signaling diagram of the preferred embodiment of the present invention in which particular messaging is utilized between the Agent 52 and Managers 54 and 56. Shown in FIG. 4 is the same AMS 100 as in FIG. 3 wherein similar elements are represented using identical numerals although for simplicity purposes, not all the messages and elements of FIG. 3 are represented in FIG. 4. With reference now being jointly made to both FIG. 3 and FIG. 4, the rebuilt notification 120 shown in FIG. 3 may be replaced, as shown in FIG. 4, by a NotifyFaultyAlarmList( ) notification 200 that may comprise i) an agent identification 202 indicative that all alarms of that given agent may be corrupted. Alternatively, the NotifyFaultyAlarmList( ) notification 200 may comprise the MOI 122 as described with reference to FIG. 3. The NotifyFaultyAlarmList( ) notification 200 shown in FIG. 4 may further comprise ii) a parameter relating to the reason of the alarm list rebuild decided by agent 52, such as Reason 119. Furthermore, the transmission 128 shown in FIG. 3, as well as the one or more alarm batches 130ᵢ may comprise one or more NotifyAlarmListRebuild notification 220, as shown in FIG. 4, carrying at least part of the newly rebuilt alarm list. The NotifyAlarmListRebuild notification 220 of FIG. 4 may comprise an AlarmInfoList parameter 222 carrying the part of, or all of the newly rebuilt alarm list, and the reason 119 indicating why the alarm list has been rebuilt.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A first network entity of an Alarm Management System (AMS) connected to at least one managed Network Element (NE) and receiving alarm notifications from the NE, the first network entity comprising an Alarm notifications List (AL), wherein when the first network entity rebuilds at least a portion of the AL, the first network entity sends a rebuild notification to at least one second network entity of the AMS indicating it is in a process of rebuilding the at least a portion of the AL, the first network entity further rebuilds the at least a portion of the AL, and once the rebuilt is completed, transmits information from the rebuilt AL to the second network entity.

2. The first network entity claimed in claim 1, wherein, the first network entity is an agent, the second network entity is a manager, and the AL is an Agent Alarm List (AAL).

3. The agent claimed in claim 2, wherein the agent rebuilds the at least a portion of the AAL upon detecting or suspecting a corruption of the at least a portion of the AAL.

4. The agent claimed in claim 2, wherein the rebuild notification sent to the at least one manager of the AMS comprises a Managed Object Instance (MOI) indicative of a Network Element (NE) whose related alarm notifications are being rebuilt by the agent.

5. The agent claimed in claim 2, wherein the rebuild notification sent to the at least one manager of the AMS is sent through a notification channel connecting the agent and the at least one manager.

6. The agent claimed in claim 2, wherein the agent transmits alarm notifications from the at least a portion of the rebuilt AAL to the at least one manager without any request received from the at least one manager.

7. The agent claimed in claim 2, wherein the agent transmits the at least a portion of the rebuilt AAL to the at least one manager through at least one batch of alarm notifications.

8. The agent claimed in claim 7, wherein the alarm notifications of each batch are marked as belonging to a given batch of alarm notifications.

9. The agent claimed in claim 2, wherein the rebuild notification further comprises a reason parameter indicative of why the AAL is rebuilt.

10. The agent claimed in claim 2, wherein the rebuild notification is a NotifyFaultyAlarmList( ) notification.

11. The agent claimed in claim 10, wherein the NotifyFaultyAlarmList( ) notification comprises an Agent Identification representative of an agent whose related AAL is rebuilt.

12. The agent claimed in claim 2, wherein when the agent transmits information from the rebuilt AAL to the manager, the agent transmits a NotifyAlarmListRebuilt message comprising an AlarmInfoList parameter with at least a portion of the AAL.

13. A second network entity of an Alarm Management System (AMS) connected to a first second entity of the AMS and receiving alarm notifications from the first network entity, the second network entity receiving from the first network entity a rebuild notification indicating the first network entity is in a process of rebuilding at least a portion of its Alarm notifications List (AL), and responsive to the receipt of the rebuild notification from the first network entity, the second network entity halting a processing of alarm notifications related to the at least a portion of the AL being rebuilt.

14. The second network entity claimed in claim 13, wherein, the first network entity is an agent of the AMS, the second network entity is a manager of the AMS, and the AL is an Agent Alarm List (AAL).

15. The manager claimed in claim 14, wherein following a completion of the process of rebuilding the at least a portion of the AAL by the agent, the manager receives from the agent alarm notifications from the at least a portion of the AAL.

16. The manager claimed in claim 14, wherein the agent communicates with the manager through a notification channel connecting the agent and the manager.

17. The manager claimed in claim 14, wherein the manager receives from the agent alarm notifications from the at a portion of the AAL without any request sent from the manager to the agent.

18. The manager claimed in claim 14, wherein responsive to the receipt of the rebuild notification from the agent, the manager starts purging at least a portion of a Manager Alarm List (MAL) comprising alarm notifications corresponding to the at least a portion of the AAL being rebuilt by the agent.

19. The manager claimed in claim 18, wherein the rebuild notification received by the manager comprises a Managed Object Instance (MOI) indicative of a Network Element (NE) whose related alarm notifications are being rebuilt by the agent.

20. The manager claimed in claim 14 further comprising a Manager Alarm List (MAL), wherein upon receipt of the alarm notifications from the at least a portion of the AAL, the manager restores at least a portion of the MAL using the alarm notifications from the at least a portion of the AAL.

21. The manager claimed in claim 14, wherein the rebuild notification further comprises a reason parameter indicative of why the AAL is rebuilt.

22. The manager claimed in claim 14, wherein the rebuild notification is a NotifyFaultyAlarmList( ) notification.

23. The manager claimed in claim 14, wherein the NotifyFaultyAlarmList( ) notification comprises an Agent Identification representative of an agent whose related AAL is rebuilt.

24. The manager claimed in claim 15, wherein the manager receives from the agent alarm notifications from the at least a portion of the AAL through a NotifyAlarmListRebuilt message sent from the agent and comprising an AlarmInfoList parameter with at least a portion of the AAL.

25. A method of synchronizing an Alarm notifications List (AL) of a first network entity of an Alarm Management System (AMS) and an Alarm notification List (MAL) of a second network entity, the method comprising the steps of:
upon deciding a rebuild of at least a portion of the AL, sending from the first network entity to the second network entity a rebuild notification indicative of an ongoing rebuild process of the at least a portion of the AL;
upon receipt of the rebuild notification by the second network entity, the second network entity halting a processing involving alarm notifications related to the at least a portion of the AAL;
the first network entity completing the rebuild of the at least a portion of the AL, and
following a completion of the rebuild process, the first network entity sending to the second network entity alarm notifications from the at least a portion of the AL that was rebuilt.

26. The method claimed in claim 25, wherein the fist network entity is an agent of the AMS, the Alarm notification List (AAL) of the first network entity is an Agent Alarm List, the second network entity is a manager of the AMS, and the Alarm notification List of the second network entity is a Manager Alarm List (MAL).

27. The method claimed in claim 26, wherein the agent decides to rebuild the at least a portion of the AAL upon detecting or suspecting a corruption of a data of the AAL.

28. The method claimed in claim 26, wherein the rebuilt notification comprises a Managed Object Instance (MOI) indicative of a Network Element (NE) of a managed network managed by the AMS, whose related alarm notifications in the AAL are suspected to be corrupted.

29. The method of claim 26, wherein at least one of the rebuilt notification and the alarm notifications from the at least a portion of the AAL that was rebuilt, is sent from the agent to the manager through a notification channel connecting the agent and the manager.

30. The method of claim 26, wherein upon receipt of the rebuild notification, the manager also starts purging at least a portion of its MAL.

31. The method of claim 30, wherein upon receipt of the rebuild notification by the manager, the manager also starts purging the at least a portion of the MAL comprising alarm notifications related to the MOI.

32. The method of claim 26, wherein the step of sending to the manager alarm notifications from the rebuilt AAL comprises sending the alarm notifications using at least a batch of alarm notifications.

33. The method of claim 32, wherein the alarm notifications of each batch are marked as relating to that batch.

34. The method of claim 26, wherein the step of sending to the manager alarm notifications from the at least a portion of the AAL that was rebuilt is performed without any request being first sent from the manager to the agent.

35. The method claimed in claim 26, further comprising the step of:
receiving at the manager the alarm notifications from the at least a portion of the AAL that was rebuilt;
restoring at the manager at least a portion of the MAL using the alarm notifications from the at least a portion of the AAL that was rebuilt.

36. The method claimed in claim 35, further comprising the step of: the manager resuming a normal processing following the step of restoring the at least a portion of the MAL.

37. The method claimed in claim 26, wherein the rebuild notification further comprises a reason parameter indicative of why the AAL is rebuilt.

38. The method claimed in claim 26, wherein the rebuild notification is a NotifyFaultyAlarmList( ) notification.

39. The method claimed in claim 26, wherein the step of sending to the manager alarm notifications from the at least a portion of the AAL that was rebuilt comprises sending from the agent a NotifyAlarmListRebuilt message comprising an AlarmInfoList parameter with the at least a portion of the AAL that was rebuilt.

40. An Alarm Management System (AMS) comprising:
an first network entity having an Alarm notifications List (AL) for storing alarm notifications received from Network Elements (NEs) of a managed network connected to the first network entity; and
a second network entity connected to the first network entity and having an Alarm notifications List (MAL) for storing alarm notifications received from the first network entity;
wherein upon beginning a rebuild of at least a portion of the AL, the first network entity sends to the second network entity a rebuild notification indicative of an ongoing rebuild process of the at least a portion of the AL, upon receipt of the rebuild notification the second network entity halts a processing involving at least a portion of the MAL comprising alarm notifications related to the at least a portion of the AL and, once the first network entity completes the rebuild, it sends to the second network entity alarm notifications from the rebuilt portion of the AL.

41. The system claimed in claim 40, wherein the rebuilt notification comprises a Managed Object Instance (MOI) indicative of at least one NE whose related event notifications in the AL are suspected to be corrupted.

42. The system claimed in claim 40, wherein the fist network entity is an agent of the AMS, the Alarm notification List (AL) of the first network entity is an Agent Alarm List (AAL), the second network entity is a manager of the AMS, and the Alarm notification List of the second network entity is a Manager Alarm List (MAL).

43. The system of claim 42, further comprising a notification channel between the agent and the manager, wherein at least one of the rebuilt notification and the alarm notifications from the rebuilt portion of the AAL is sent from the agent to the manager through a notification channel connecting the agent and the manager.

44. The system of claim 42, wherein upon receipt of the rebuild notification by the manager, the manager also starts purging at least a portion of its MAL.

45. The system of claim 44, wherein the at least a portion of the MAL comprises alarm notifications related to the MOI.

46. The system of claim 42, wherein the agent sends to the manager alarm notifications from the rebuilt MAL using at least a batch of alarm notifications.

47. The system of claim 46, wherein the alarm notifications of each batch are marked as belonging to that batch of alarm notifications.

48. The system of claim 42, wherein the agent sends to the manager alarm notifications from the at least a portion of the rebuilt AAL without any request being sent from the manager to the agent.

49. The system claimed in claim 42, wherein upon receiving the alarm notifications from the at least a portion of the AAL that was rebuilt, the manager restores at least a portion of the MAL using the alarm notifications from the at least a portion of the AAL that was rebuilt.

50. The system claimed in claim 49, wherein the manager further resumes a normal processing following the restoring of the at least a portion of the MAL.

51. The system claimed in claim 42, wherein the rebuild notification further comprises a reason parameter indicative of why the AAL is rebuilt.

52. The system claimed in claim 42, wherein the rebuild notification is a NotifyFaultyAlarmList( ) notification.

53. The system claimed in claim 42, wherein when the agent sends to the manager alarm notifications from the rebuilt portion of the AAL, the agent sends a NotifyAlarmListRebuilt message comprising an AlarmInfoList parameter with the at least a portion of the AAL that was rebuilt.
